(19) United States
(12) Patent Application Publication
(10) Pub. No.: US 2007/0026913 A1
(43) Pub. Date: Feb. 1, 2007

(54) Crop processing element for a rotary combine

(76) Inventor: George J. Kuchar, Carlinville, IL (US)

Correspondence Address: ROBERT M. HUNTER PLLC, P.O. BOX 2709, KAMUELA, HI, 96743, US

(21) Appl. No.: 11/493,491

(22) Filed: Jul. 24, 2006

Related U.S. Application Data
(60) Provisional application No. 60/703,290, filed on Jul. 27, 2005.

(51) Int. Cl. A01F 12/40

(52) U.S. Cl. 460/112

(57) ABSTRACT

An apparatus and method for improving the ability of a rotary combine to gently thresh a crop and to gently convey the crop through the threshing section of the combine. In a preferred embodiment, the invention is a crop engaging element for the rotor of a rotary combine, said crop engaging element comprising: a mounting structure having a ramp portion terminating in a top portion; a rasp bar comprising a base having a bottom surface and a curved convex top surface and a plurality of fins extending from said top surface; a leading mounting flange and a trailing mounting flange that extend from the mounting structure for mounting the crop engaging element to the rotor.

### CROSS-REFERENCE TO RELATED APPLICATIONS

This application claims the benefit of U.S. Provisional Patent Application No. 60/703,290, filed Jul. 27, 2005, pending, the disclosure of which patent application is incorporated by reference as if fully set forth herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

This invention relates to a crop processing element for a rotary combine. In particular, the invention relates to a rasp bar assembly for a rotor for a rotary combine, a cylinder for a rotary combine, and a rotary combine having such a cylinder.

Background art rotary combines comprise an axial crop processing unit that houses a rotor. The rotor comprises a cylindrical drum upon which crop engaging elements are mounted. These crop engaging elements often comprise rasp bars having fins. These background art fins are oriented at an angle of sixty degrees relative to a radial plane of the cylindrical drum or rotor or thirty degrees relative to an axial plane of the cylindrical drum or rotor. The leading edge of the rasp bar is typically coincident with an axial plane of the cylindrical drum or rotor, and the background art fins are oriented at an angle of sixty degrees relative to the rasp bar leading edge.

The background art is characterized by U.S. Pat. Nos. 4,796,645; 4,889,517; 4,909,772; 4,964,838; 5,192,245; 5,192,246; 5,376,047; 5,487,703; 5,556,337; 5,688,170; and 6,036,598; the disclosures of which patents are incorporated by reference as if fully set forth herein.

### BRIEF SUMMARY OF THE INVENTION

The purpose of the invention is to improve the crop processing efficiency of a rotary combine. One advantage of preferred embodiments of the invention is that it can significantly increase the yield of a combine that incorporates it. Another advantage of preferred embodiments of the invention is that it can reduce the amount of straw that is processed by the combine from being broken up into small particles. Another advantage of preferred embodiments of the invention is that the portion of the crop engaging element that is most exposed to wear, the rasp bar portion, is separately replaceable from the mounting structure portion. Another advantage of preferred embodiments of the invention is that it will allow the harvesting of pharmaceutical crops. Crops are now grown for harvesting to gain components used in the pharmaceutical industry which require a less harmful harvesting process. Another advantage of preferred embodiments of the invention is that it moves the material being threshed as a slower rate, which results in more thorough threshing or separation of the crop, less damage to the crop and reduced plugging of the threshing system.

The invention is an apparatus and method for improving the ability of a rotary combine to gently thresh a crop and to gently convey the crop through the threshing section of the combine. In a preferred embodiment, the threshing elements of the present invention are mounted on the threshing section of the rotor of a crop processing unit of a rotary combine. In this embodiment, the threshing section downstream from the helical blades of the infeed section and upstream from the separator tines of the separation section of the crop processing unit. In this embodiment, the rotor is housed in a rotor housing that has cage vanes mounted in a helical orientation along its upper surface and a concave along its lower surface. In use, the threshing elements of a preferred embodiment of the present invention move crop between the rotor housing and the rotating rotor and simultaneously thresh the crop.

In a preferred embodiment, the invention is a crop engaging element for the rotor of a rotary combine, said crop engaging element comprising: a hollow mounting structure having a ramp portion terminating in a flat top portion that is provided with at least one hole; a rasp bar comprising a base having a flat bottom surface and a curved convex top surface and a plurality of fins extending from said top surface, each of said plurality of fins having a fin longitudinal axis, and said base being provided with at least one (and preferably two) mounting holes through which a threaded fastener is passed to mount said rasp bar to said hollow mounting structure; a leading mounting flange and a trailing mounting flange that extend from the hollow structure for mounting the crop engaging element to the rotor, wherein one of said mounting flanges is provided with at least one (and preferably two) circular mounting apertures and the other of said mounting flanges is provided with at least one (and preferably two) mounting apertures in the form of a slot through which mounting bolts are passed to mount the crop engaging element on the rotor. Preferably, said hollow mounting structure is a single structure of unitary construction. Preferably, said fin longitudinal axes are substantially parallel. In a preferred embodiment, the crop engaging element further comprises a rear wall, wherein said trailing mounting flange is provided with at least one (and preferably two) gussets extending between said trailing mounting flange and said rear wall. Preferably, said rear wall is open forming a rectangular frame.

In another preferred embodiment, the invention is a crop engaging element for the rotor of a rotary combine, said crop engaging element comprising: a hollow structure having a ramp portion terminating in a flat top portion that is provided with a rasp bar, said rasp bar comprising a base having a curved convex top surface and a plurality of fins (preferably nine) extending from said surface, each of said plurality of fins having a fin longitudinal axis; and a leading mounting flange and a trailing mounting flange extend from the hollow structure for mounting the crop engaging element to a rotor, wherein one of said mounting flanges (preferably the leading mounting flange) is provided with a first mounting aperture and the other of said mounting flanges (preferably the trailing mounting flange) is provided with a second mounting aperture (preferably a slot) through which mounting bolts are passed to mount the crop engaging element on the rotor.

In yet another preferred embodiment, the invention is a crop processing rotor for a rotary agricultural combine or a rotary pharmaceutical combine, said crop processing rotor comprising: a cylindrical drum; and a plurality of crop processing elements mounted to said cylindrical drum, each of said crop processing elements comprise a crop engaging disclosed herein.

In a further preferred embodiment, the invention is a rotary agricultural or pharmaceutical combine comprising: a concave; and a crop processing rotor disclosed herein, said crop processing rotor being rotatably mounted in said concave.

In another preferred embodiment, the invention is a method for improving the ability of a rotary combine to gently thresh a crop and to gently convey the crop through the threshing section of the rotary combine, said method comprising: introducing the crop to the threshing section of the rotary combine; and rotating within said threshing section a rotor upon which are mounted a plurality of crop engaging elements (preferably in a helical pattern), each said crop engaging element comprising a single, unitary, hollow structure having a ramp portion terminating in a flat top portion that is provided with at least one hole, a rasp bar comprising a base having a flat bottom surface and a curved convex top surface and a plurality of fins extending from said top surface, and said base being provided with at least one mounting hole through which a threaded fastener is passed to mount said rasp bar to said hollow structure, and a leading mounting flange and a trailing mounting flange that extend from the hollow structure for mounting the crop engaging element to the rotor, wherein one of said mounting flanges is provided with at least one circular mounting aperture and the other of said mounting flanges is provided with at least one mounting aperture in the form of a slot through which mounting bolts are passed to mount the crop engaging element on the rotor.

In another preferred embodiment, the invention is a method for improving the ability of a rotary combine to gently thresh a crop and to gently convey the crop through the threshing section of the rotary combine, said method comprising: introducing the crop to the threshing section of the rotary combine; and rotating within said threshing section a rotor upon which are mounted a plurality of crop processing elements, each said crop engaging element comprising a crop engaging element disclosed herein.

In another preferred embodiment, the invention is a crop engaging element for the rotor of a rotary combine, the rotor having a plurality of radial planes, said crop engaging element comprising: a hollow structure having a ramp portion terminating in a top portion; a rasp bar that is attached to said top portion, said rasp bar comprising a base having a curved convex top surface and a plurality of fins extending from said surface, each of said plurality of fins having a fin longitudinal axis; whereas said fin longitudinal axes are substantially parallel to one another and are oriented at an angle relative to one of the radial planes of rotation, said angle being in the range of about forty-one to about fifty-nine degrees or in the range of about sixty-one degrees to about eighty-nine degrees. Preferably, said angle is about fifty degrees. Preferably, said angle is about seventy degrees. Preferably, said angle is in the range of about forty-two degrees to about fifty-eight degrees. Preferably, said angle is in the range of about sixty-two degrees to about eighty-eight degrees.

In yet another preferred embodiment, the invention is a crop engaging element for the rotor of a rotary combine, the rotor having a plurality of radial planes, said crop engaging element comprising: a rasp bar mount that is attached to the rotor, said rasp bar mount having a ramp portion and a rasp bar portion, said rasp bar having a plurality of fins, each of said fins having a longitudinal fin axis, each longitudinal axis being disposed at an angle relative to one of said radial planes; wherein said angle is in the range of about forty-two degrees to about fifty-eight degrees or about sixty-two degrees to about eighty-eight degrees. Preferably, said angle is about fifty degrees. Preferably, said angle is about seventy degrees. Preferably, said rasp bar mount and said rasp bar portion make up a single, unitary cast metal structure.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWINGS

The features of the invention will be better understood by reference to the accompanying drawings which illustrate presently preferred embodiments of the invention. In the drawings:

FIG. 1 is a schematic elevation view of a rotary agricultural or pharmaceutical combine in accordance with a preferred embodiment of the present invention.

FIG. 2 is an elevation view of a rotor of an axial crop processing unit in accordance with a preferred embodiment of the present invention with the rotor housing shown partially cut away.

FIG. 3 is a cross-sectional view of the threshing section of an axial crop processing unit in accordance with a preferred embodiment of the present invention.

FIG. 4 is an elevation view of a first portion of a crop engaging element in accordance with a preferred embodiment of the present invention.

FIG. 5 is a plan view of a first portion of a crop engaging element in accordance with a preferred embodiment of the present invention.

FIG. 6 is a cross-sectional view of a first portion of a crop engaging element in accordance with a preferred embodiment of the present invention.

FIG. 7 is a plan view of a second portion of a crop engaging element in accordance with a preferred embodiment of the present invention.

FIG. 8 is a cross-section view of the second portion of a crop engaging element in accordance with a preferred embodiment of the present invention.

FIG. 9 is a cross-section view of three of the fins of the second portion of a crop engaging element in accordance with a preferred embodiment of the present invention.

FIG. 10 is an elevation view of a crop engaging element in accordance with a preferred embodiment of the present invention.

The following reference numerals are used to indicate the parts and environment of the invention on the drawings:
10 rotary agricultural or pharmaceutical combine, rotary combine, combine
12 supporting structure
14 wheels
16 harvesting platform
18 feeder house
20 crop beater
22 inlet transition section
24 axial crop processing unit, crop processing unit
26 cleaning system
28 clean grain tank
30 unloading auger
32 outlet
34 discharge beater
36 operator's cab
38 rotor housing, housing
39 rotor
42 helical blades
44 separator tines
46 concave
50 crop engaging elements, threshing elements
74 cage vanes
76 first portion, mounting bracket, rasp bar mount
80 structure
82 ramp portion
84 top portion
85 threaded hole
86 leading mounting flange
88 trailing mounting flange
89 plane of rotation
90 circular mounting aperture
92 slot
94 rear wall
96 gusset
98 rectangular frame
100 second portion, rasp bar
102 base
104 fins
105 fin longitudinal axis
106 bottom surface
108 top surface
110 mounting hole
112 radial plane

### DETAILED DESCRIPTION OF THE INVENTION

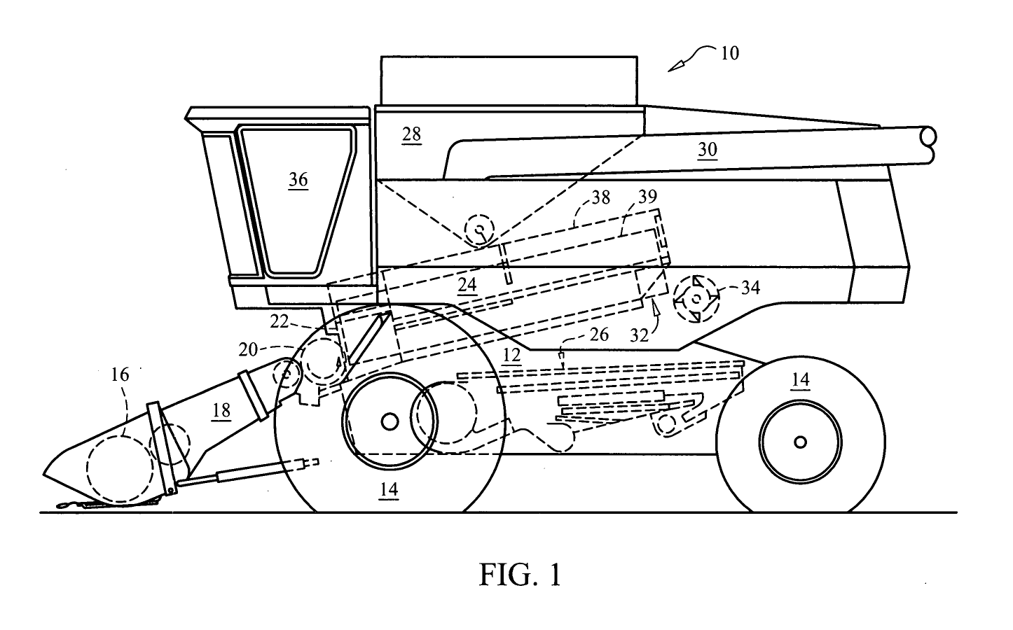

Referring to FIG. 1, a preferred embodiment of rotary agricultural or pharmaceutical combine 10 is presented. Agricultural or pharmaceutical combine 10 comprises supporting structure 12 having ground engaging wheels 14. In this embodiment, harvesting platform 16 harvests a crop and directs it to feeder house 18. The harvested crop is directed by feeder house 18 to crop beater 20. Crop beater 20 directs the crop upwardly through inlet transition section 22 to axial crop processing unit 24.

Axial crop processing unit 24 threshes and separates the harvested crop material. Grain and chaff fall through concaves and grates on the bottom of axial crop processing unit 24 into cleaning system 26. Cleaning system 26 removes the chaff and directs the clean grain to a clean grain elevator (not shown). The clean grain elevator deposits the clean grain in grain tank 28. The clean grain in the tank can be unloaded into a grain cart or truck by unloading auger 30.

Threshed and separated straw is discharged from axial crop processing unit 24 through outlet 32 to discharge beater 34. Discharge beater 34 in turn propels the straw out the rear of combine 10. The operation of combine 10 is controlled from operator's cab 36.

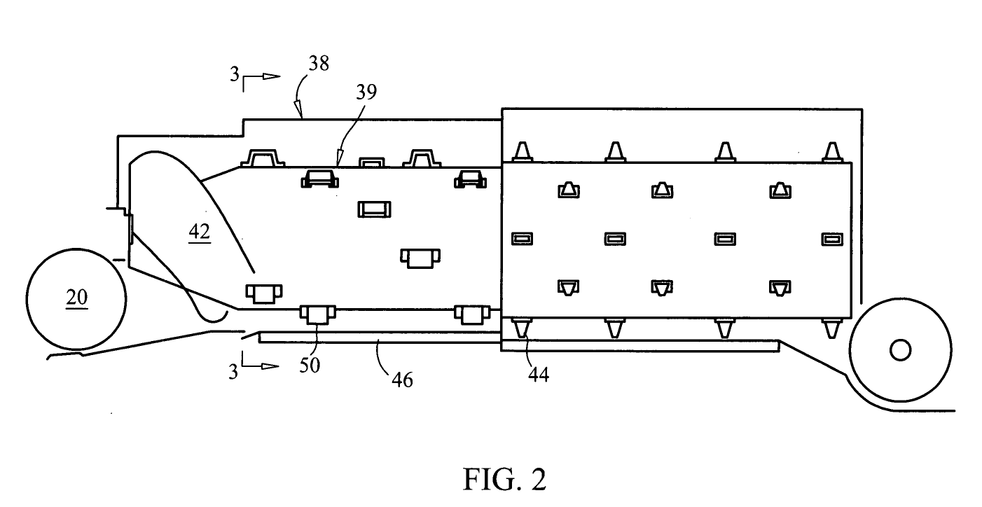

Referring to FIG. 2, axial crop processing unit 24 preferably comprises rotor housing 38 and rotor 39 located inside rotor housing 38. The front part of rotor 39 and rotor housing 38 define the infeed section of the crop processing unit. In this section, rotor 39 is preferably provided with a drum having helical blades 42 for engaging crop material that is discharged from crop beater 20. Immediately downstream from the infeed section is the threshing section of crop processing unit 24. In the threshing section, rotor 39 preferably comprises a cylindrical drum upon which a plurality of crop engaging elements 50 are mounted, preferably in multiple helical paths. Immediately downstream of the threshing section is the separating section of crop processing unit 24. In the separating section, a plurality of separator tines 44 are preferably mounted on the cylindrical drum. Preferably, cage vanes are mounted on the top of rotor housing 38, preferably in multiple helical paths.

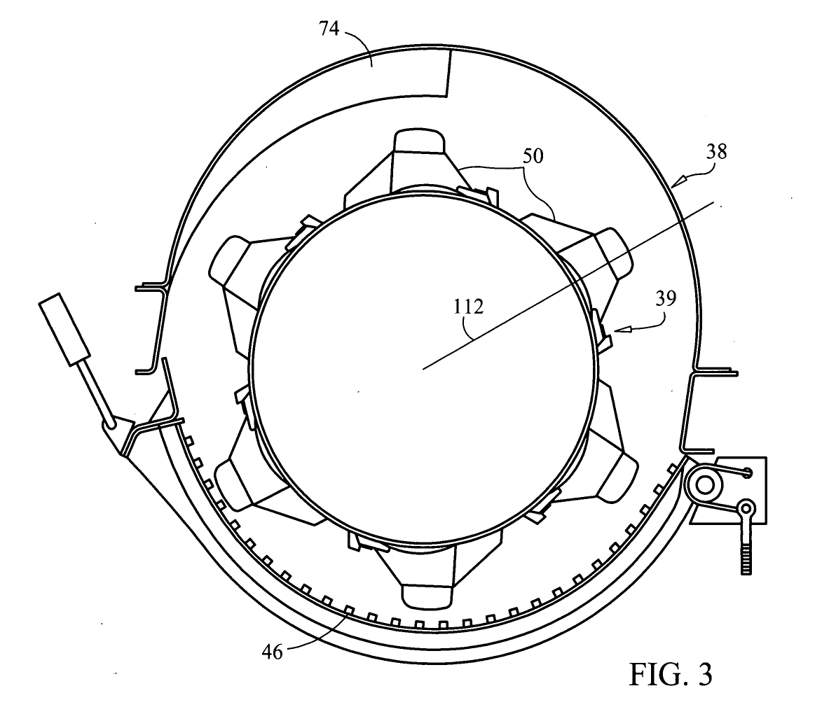

Referring to FIG. 3, a preferred embodiment of the threshing section of crop processing unit 24 is illustrated. Crop processing elements 50 are shown mounted on rotor 39. Preferably, cage vanes 74 are mounted on the top of rotor housing 38, preferably in multiple helical paths. Concave 46 is mounted below rotor 39. Radial plane 112 of rotor 39 is illustrated.

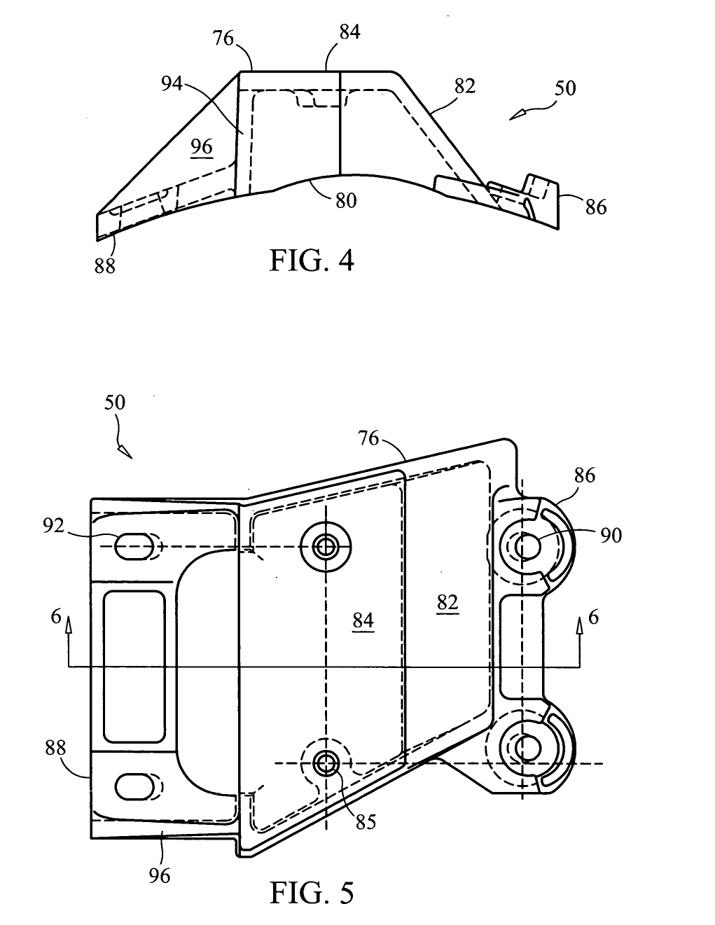

Referring to FIG. 4, a preferred embodiment of first portion 76 of crop engaging element 50 is presented in a side view. In this embodiment, structure 80 of crop engaging element 50 is hollow and comprises ramp portion 82 and top portion 84 that is preferably flat and provided with at least one threaded hole 85. Leading mounting flange 86 forms the structure leading edge of structure 80. Trailing mounting flange 88 forms the structure trailing edge of structure 80. At least one of mounting flanges 86 or 88 is provided with at least one circular mounting aperture 90 and the other of said mounting flanges 86 or 88 is provided with at least one mounting aperture in the form of slot 92 through which mounting bolts (not shown) are passed to mount each of the crop engaging elements 50 on rotor 39. In this embodiment, structure 80 comprises rear wall 94 and trailing mounting flange 88 is provided with at least one gusset 96 extending between trailing mounting flange 88 and rear wall 94.

Referring to FIG. 5, a preferred embodiment of first portion 76 of crop engaging element 50 is presented in a top view. In this embodiment, two circular mounting apertures 90, two slots 92, two threaded holes 85 and two gussets 96 are provided. Preferably, the centers of one of the pairs of circular mounting apertures 90, slots 92 and threaded holes 85 lie in plane of rotation 89 of rotor 39 when each crop engaging element 50 is mounted on rotor 39.

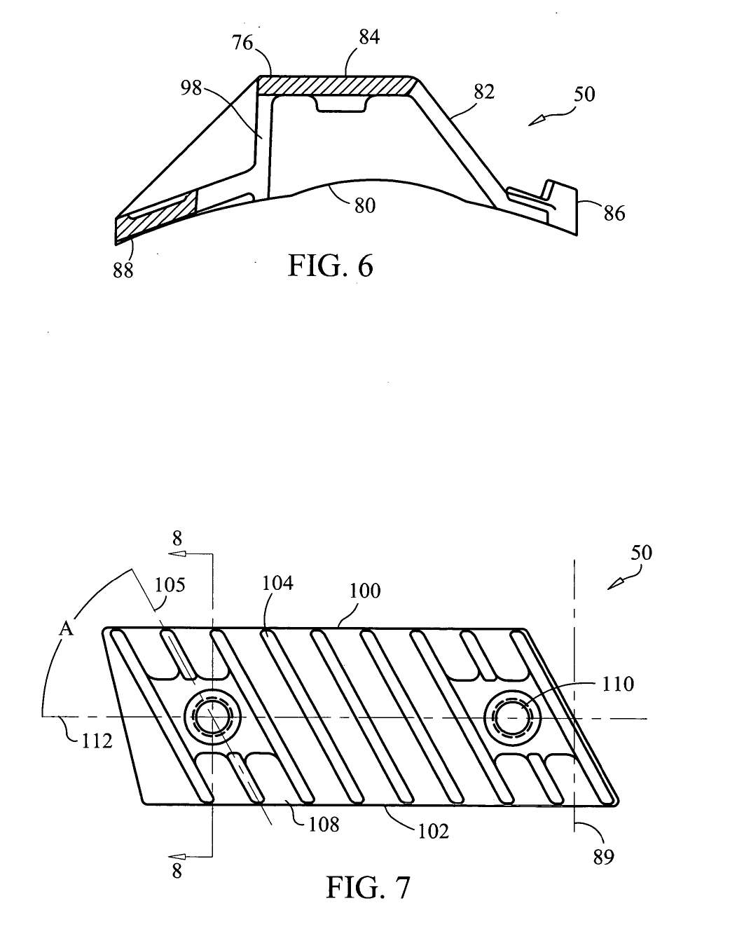

Referring to FIG. 6, a cross-sectional view of a preferred embodiment of first portion 76 of crop engaging element 50 is presented. In this embodiment, rear wall 94 is open, forming rectangular frame 98. In this view, the leading edge of crop engaging element 50 is on the right and the trailing edge of crop engaging element 50 is on the left.

Referring to FIG. 7, second portion or rasp bar 100 of a preferred embodiment of crop engaging element 50 is shown in plan. In this view, the leading edge of rasp bar 100 is on the top and the trailing edge of rasp bar 100 is on the bottom. In this embodiment, rasp bar 100 preferably comprises base 102 and plurality of fins 104 extending from top surface 108. When installed, each rasp bar 100 preferably has plane of rotation 89 that is perpendicular to radial plane 112. Each of the fins 104 preferably has fin longitudinal axis 105.

In a preferred embodiment, each fin longitudinal axis 105 is oriented at angle A of about 70 degrees relative to radial plane 112 of rotor 39 when each crop engaging element 50 is mounted on rotor 39. In another preferred embodiment, angle A is in the range of about sixty-one degrees to about eighty-nine degrees. In another preferred embodiment, angle A is about fifty degrees plus or minus about eight degrees. In another preferred embodiment, angle A is about seventy degrees plus or minus about eight degrees. Base 102 is preferably provided with at least one (and preferably two) mounting holes 1 10 through which a threaded fastener, e.g., a bolt, (not shown) is passed to mount rasp bar 100 on structure 80.

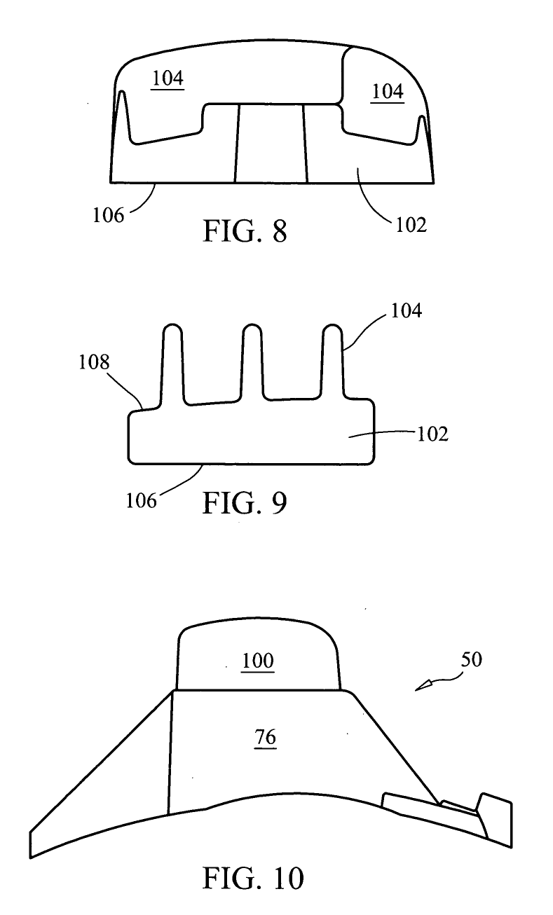

Referring to FIGS. 8 and 9, portions of rasp bar 100 of crop engaging element 50 is shown in cross section. The leading edge of rasp bar 100 is on the left and the trailing edge is on the right in FIG. 8. In this embodiment, base 102 has flat bottom surface 106 and curved convex top surface 108. Fins 104 extend from bottom surface 106. Both base 102 and fins 104 preferably have smooth surfaces and rounded edges. Preferably, structure 80 and rasp bar 100 are fabricated of cast metal.

Referring to FIG. 10, first portion 76 and second portion or rasp bar 100 of a preferred embodiment of crop engaging element 50 are shown assembled. In this embodiment, two bolts (not shown) are used to fasten second portion 100 to first portion 76. As is the case in FIG. 6, in this view, the leading edge of crop engaging element 50 is on the right and the trailing edge of crop engaging element 50 is on the left.

In the preferred embodiments described above, crop engaging element 50 does not have the concave trough or the radially extending lip of the crop engaging assembly disclosed in U.S. Pat. No. 5,688,170 (see FIG. 4 of that patent) and the crop engaging element disclosed in U.S. Pat. No. 6,036,598 (see FIGS. 2-4 of that patent), the disclosures of which patents are incorporated by reference as if fully set forth herein. The crop processing unit disclosed herein is an improvement in part because it imposes much lower shearing forces on the crop that it processes, resulting in much less straw breakage. Moreover, in the preferred embodiments disclosed above, crop processing element 50 has utility in axial crop processing units other than those in which the axis of threshing section is offset from the axes of the other sections as is claimed in U.S. Pat. No. 5,688,170. For example, the applicant believes that crop processing element 50 also has utility as a component of other axial flow harvesting machines, including those disclosed in U.S. Pat. Nos. 4,889,517; 4,964,838 and 5,192,245, the disclosures of which patents are incorporated by reference as if fully set forth herein, as a replacement for the rasp bar/rasp bar mounts assemblies disclosed therein. Furthermore, in the preferred embodiments described above, rasp bar 100 does not have first portion of U.S. Pat. No. 5,192,245, the disclosure of which patent is incorporated by reference as if fully set forth herein, because ramp portion 82 serves a similar purpose.

In an alternate embodiment, rasp bar 100 is cast as part of mounting bracket 76. In this embodiment, rasp bar 100 and mounting bracket are a cast metal, one piece structure.

Many variations of the invention will occur to those skilled in the art. Some variations include a two-part crop engaging element. Other variations call for a single part crop engaging element. All such variations are intended to be within the scope and spirit of the invention.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of the invention.

What is claimed is:

1. A crop engaging element for the rotor of a rotary combine, said crop engaging element comprising:
a hollow mounting structure having a ramp portion terminating in a flat top portion that is provided with at least one hole;
a rasp bar comprising a base having a flat bottom surface and a curved convex top surface and a plurality of fins extending from said top surface, each of said plurality of fins having a fin longitudinal axis, and said base being provided with at least one mounting holes through which a threaded fastener is passed to mount said rasp bar to said hollow mounting structure;
a leading mounting flange and a trailing mounting flange that extend from said hollow structure for mounting the crop engaging element to the rotor, wherein one of said mounting flanges is provided with at least one circular mounting apertures and the other of said mounting flanges is provided with at least one mounting apertures in the form of a slot through which mounting bolts are passed to mount the crop engaging element on the rotor.

2. The crop engaging element of claim 1 wherein said hollow mounting structure is a single structure of unitary construction.

3. The crop engaging element of claim 1 wherein said hollow mounting structure, said rasp bar, said leading mounting flange and said trailing mounting flange are a single structure of unitary construction.

4. The crop engaging element of claim 1 wherein said fin longitudinal axes are substantially parallel.

5. The crop engaging element of claim 1 further comprising:
a rear wall;
wherein said trailing mounting flange is provided with at least one gusset extending between said trailing mounting flange and said rear wall.

6. The crop engaging element of claim 5 wherein said rear wall is open forming a rectangular frame.

7. A crop engaging element for the rotor of a rotary combine, said crop engaging element comprising:
a hollow structure having a ramp portion terminating in a flat top portion that is provided with a rasp bar, said rasp bar comprising a base having a curved convex top surface and a plurality of fins extending from said surface, each of said plurality of fins having a fin longitudinal axis; and
a leading mounting flange and a trailing mounting flange extend from the hollow structure for mounting the crop engaging element to a rotor, wherein one of said mounting flanges is provided with a first mounting aperture and the other of said mounting flanges is provided with a second mounting aperture through which mounting bolts are passed to mount the crop engaging element on the rotor.

8. A crop processing rotor for a rotary agricultural combine or a rotary pharmaceutical combine, said crop processing rotor comprising:
a cylindrical drum; and
a plurality of crop processing elements mounted to said cylindrical drum, each of said crop processing elements comprising the crop engaging element of claim 1.

9. A rotary agricultural or pharmaceutical combine comprising:
a concave; and
a crop processing rotor assembly comprising the crop processing rotor of claim 8, said crop processing rotor being rotatably mounted in said concave.

10. A method for improving the ability of a rotary combine to gently thresh a crop and to gently convey the crop through the threshing section of the rotary combine, said method comprising:
introducing the crop to the threshing section of the rotary combine; and
rotating within said threshing section a rotor upon which are mounted a plurality of crop engaging elements, each said crop engaging element comprising a single, unitary, hollow structure having a ramp portion terminating in a flat top portion that is provided with at least one hole, a rasp bar comprising a base having a flat bottom surface and a curved convex top surface and a plurality of fins extending from said top surface, and said base being provided with at least one mounting hole through which a threaded fastener is passed to mount said rasp bar to said hollow structure, and a leading mounting flange and a trailing mounting flange that extend from the hollow structure for mounting the crop engaging element to the rotor, wherein one of said mounting flanges is provided with at least one circular mounting aperture and the other of said mounting flanges is provided with at least one mounting aperture in the form of a slot through which mounting bolts are passed to mount the crop engaging element on the rotor.

11. A method for improving the ability of a rotary combine to gently thresh a crop and to gently convey the crop through the threshing section of the rotary combine, said method comprising:
introducing the crop to the threshing section of the rotary combine; and
rotating within said threshing section a rotor upon which are mounted a plurality of crop processing elements, each said crop engaging element comprising the crop engaging element of claim 1.

12. A crop engaging element for the rotor of a rotary combine, the rotor having a plurality of radial planes, said crop engaging element comprising:
a hollow structure having a ramp portion terminating in a top portion;
a rasp bar that is attached to said top portion, said rasp bar comprising a base having a curved convex top surface and a plurality of fins extending from said surface, each of said plurality of fins having a fin longitudinal axis;
whereas said fin longitudinal axes are substantially parallel to one another and are oriented at an angle relative to one of the radial planes of rotation, said angle being in the range of about forty-one to about fifty-nine degrees or in the range of about sixty-one degrees to about eighty-nine degrees.

13. The crop engaging element of claim 12 wherein said angle is about fifty degrees.

14. The crop engaging element of claim 12 wherein said angle is about seventy degrees.

15. The crop engaging element of claim 12 wherein said angle is in the range of about forty-two degrees to about fifty-eight degrees.

16. The crop engaging element of claim 12 wherein said angle is in the range of about sixty-two degrees to about eighty-eight degrees.

17. A crop engaging element for the rotor of a rotary combine, the rotor having a plurality of radial planes, said crop engaging element comprising:
a rasp bar mount that is attached to the rotor, said rasp bar mount having a ramp portion and a rasp bar portion, said rasp bar having a plurality of fins, each of said fins having a longitudinal fin axis, each longitudinal axis being disposed at an angle relative to one of said radial planes;
wherein said angle is in the range of about forty-two degrees to about fifty-eight degrees or about sixty-two degrees to about eighty-eight degrees.

18. The crop engaging element of claim 17 wherein said angle is about fifty degrees.

19. The crop engaging element of claim 17 wherein said angle is about seventy degrees.

20. The crop engaging element of claim 17 wherein said rasp bar mount and said rasp bar portion make up a single, unitary cast metal structure.
